(19) United States
(12) Patent Application Publication
(10) Pub. No.: US 2022/0349620 A1
(43) Pub. Date: Nov. 3, 2022

(54) HEAT-GENERATING ASSEMBLY AND METHOD FOR CONTROLLING THE ASSEMBLY

(71) Applicant: ECO-TECH CERAM, Perpignan (FR)

(72) Inventors: Antoine Meffre, Perpignan (FR); Guilhem Dejean, Perpignan (FR); Davy Bruyère, Montils (FR)

(73) Assignee: ECO-TECH CERAM, Perpignan (FR)

(21) Appl. No.: 17/633,296

(22) PCT Filed: Aug. 6, 2020
(86) PCT No.: PCT/EP2020/072169

§ 371 Date: Feb. 7, 2022

(30) Foreign Application Priority Data
Aug. 8, 2019 (FR) 1909069

(51) Int. Cl. F24H 3/04; F24H 9/00; F24H 9/20

(52) U.S. Cl. CPC F24H 3/0405; F24H 9/0063; F24H 3/0488; F24H 9/2064; F24H 9/0073

(57) ABSTRACT

A heat-generating assembly (1) includes at least one airflow generation device, air supply which is fluidically connected to the airflow generation device, and at least three heating devices, each having an air inlet connected to the air supply, and a reheated air outlet. The airflow generation device and the heating devices are controlled in that the heating devices are distributed along at least one perimeter line, and in that each perimeter line section which contains three adjacent heating devices is curvilinear.

### TECHNICAL FIELD

The invention falls within the field of heat energy generation, and relates more particularly to a heat generation assembly and to a method for controlling said assembly.

### PRIOR ART AND DISADVANTAGES OF THE PRIOR ART

Energy distribution networks, and in particular electricity distribution networks, must meet increasing demands. Moreover, renewable energies, which have the particular feature of offering discontinuous energy production, play an increasingly important role in the supply of energy. This results in peaks and troughs in production, generating imbalances in energy supply and demand.

To overcome these drawbacks, technical solutions for storing energy have been developed in recent years, in particular in the form of heat energy. The most efficient solutions must accumulate very large amounts of energy to ensure a continued recovery of energy over time. It is therefore necessary to provide powerful generators of heat energy that are capable of generating large amounts of heat in a short time.

Heat generation assemblies comprising at least one air flow generation device, air supply means fluidically connected to the air flow generation device, and two heating devices, or air guns, each comprising an air inlet connected at the outlet of the air supply means and a heated-air outlet, are known, for example from the publication US 2012 0240916. Such assemblies are indeed able to accumulate a great deal of power, around several hundred kilowatts.

However, in order to ensure a uniform distribution of the air flow, the air supply means have a complex geometry which brings about significant pressure drops.

On the other hand, because of these high powers, the temperature of the heated air reaches very high values, around several hundred degrees Celsius, and so the heat radiated by the assembly of air guns runs the risk of damaging them. It is therefore necessary to provide substantial insulating means which protect the air guns. Lastly, the sometimes large number of interconnected air guns makes maintenance operations on some of them difficult.

### AIM OF THE INVENTION

The invention therefore concerns the provision of a heat generation assembly that limits pressure drops and can be maintained more easily.

The invention also concerns the provision of a heat generation assembly that is optimized for the purpose of retaining its structural integrity in the face of the heat radiation that it generates.

The invention also concerns a method for controlling the heat generation assembly that makes it possible to manage the peaks and troughs in production of the energy distribution network.

### SUMMARY OF THE INVENTION

To that end, the invention concerns a heat generation assembly comprising at least one air flow generation device, air supply means fluidically connected to the air flow generation device, and at least three heating devices each comprising an air inlet connected to the air supply means, and a heated-air outlet, wherein the assembly comprises means for controlling the airflow generation device and the heating devices, wherein the heating devices are distributed along at least one peripheral line, and wherein each section of peripheral line that groups together three adjacent heating devices is curved.

The assembly may also have the following optional features, considered in isolation or in any possible technical combination:
The air supply means comprise at least one air distribution member formed by an arched tube in which are formed at least one air inlet connected at the outlet of the air flow generator and at least three air outlets, each being connected at the inlet of the associated heating device, and wherein each arched-tube portion that groups together three adjacent air outlets faces said section of peripheral line that groups together the three adjacent devices.
The respective ends of the arched tube are hermetically sealed.
The arched tube has a single air inlet, wherein the cross section of said arched tube gradually decreases in the direction away from the air inlet, and wherein the speed of the air flow is constant at all points of the arched tube.
The air inlet is disposed in the median plane of the arched tube, and the two portions of the arched tube extending from the air inlet are symmetrical with respect to said median plane.
The heating devices are evenly distributed along at least one circular ring.
The heating devices are distributed along at least two concentric circular rings.
The heating devices of two successive rings are disposed in a staggered manner.
The heat generation assembly comprises at least one arched tube for each concentric ring of heating devices.
The heat generation assembly comprises a frustoconical air diffuser having a plurality of air inlets, each fluidically connected at the outlet of the associated heating device, and an outlet for air heated by the heating devices.
The control means are configured to control the heating devices independently of one another.
The control means are remote and configured to communicate with the heating devices via wireless communication means included in said assembly.
Each heating device is an electric forced-air heater connected to a source of electrical energy.
Each electric heater comprises a control member of the solid-state relay type which is controlled by the control means.
Each electric heater comprises at least one heating resistor made from a metal alloy of the iron-chromium-aluminum type.
The heat generation assembly comprises between twenty and forty heating devices, preferably between thirty and thirty-five heating devices.
Each heating device is spaced apart from an adjacent heating device by a distance of at least twelve centimeters.
Each heating device comprises thermal insulation means.

The invention also concerns a method for controlling a heat generation assembly as described above, comprising the following successive steps implemented by the control means:
i. Continuously monitoring the power delivered by an energy source to which the assembly is connected;
ii. Periodically determining the maximum number of heating devices able to be supplied in the optimum case by the energy source as a function of the available power;
iii. Periodically determining the number of operational heating devices in the assembly;
iv. Regulating in real time, as a function of the available power, the number of operational heating devices such that the number of operational heating devices is at most equal to the maximum number of heating devices calculated in step ii.

### PRESENTATION OF THE FIGURES

Other features and advantages of the invention will become clearly apparent from the description which is given below by way of entirely non-limiting indication, with reference to the appended figures, in which:

FIG. 1 shows a side view of the heat generation assembly according to the invention;

FIG. 2 shows a schematic front view of an arrangement of heating devices according to a first embodiment of the invention;

FIG. 3 shows a perspective view of an air distribution member suitable for the heating devices arranged according to FIG. 2;

FIG. 4 shows a schematic front view of an arrangement of heating devices according to a second embodiment of the invention;

FIG. 5 shows a perspective view of a part of the heat generation assembly with heating devices arranged according to FIG. 4;

FIG. 6 shows a block diagram of the various steps of the method for controlling the assembly of FIG. 1.

### DETAILED DESCRIPTION OF THE INVENTION

It is first of all specified that, in the figures, the same references denote the same elements irrespective of the figure in which they appear and irrespective of the embodiment of these elements. Similarly, if elements are not expressly referenced in one of the figures, their references can be easily found by referring to another figure.

It is also specified that the figures essentially show two embodiments of the object of the invention but that there may be other embodiments which comply with the definition of the invention.

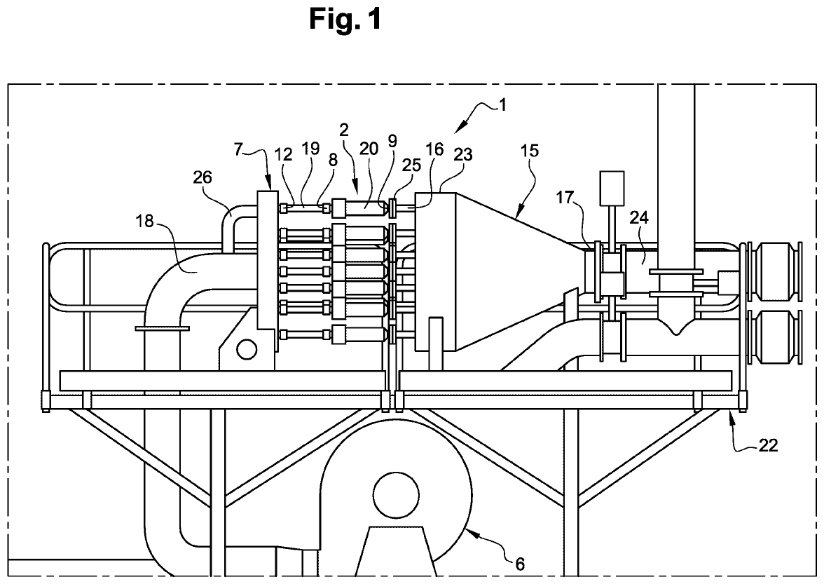

With reference to FIGS. 1 and 5, the heat generation assembly 1 is fixed on a frame 22 which rests on the ground, and comprises a plurality of heating devices 2 known as “forced-air heater” or else “hot-air gun” or simply “air gun”. It is this latter term which will be used in the remainder of the description.

An air gun 2 is a device generally comprising a ventilation tube 20 with a cylindrical or polygonal profile, inside which are arranged means for heating the air flow that passes through the tube 20. In addition, so as to generate a flow of air to be heated as it passes through the ventilation tube 20 of each air gun 2, the heat generation assembly comprises an air flow generation device 6, in particular a ventilation device fluidically connected at the inlet 8 of each air gun 2 by way of a main duct 18, itself connected to air supply means 7, 7a comprising at least one air inlet fluidically connected to said main duct 18, and a plurality of air outlets 12 connected to the inlets 8 of the ventilation tubes 20 of the air guns 2. These air supply means 7, 7a will be described in more detail below.

Thus, when the air flow generation device 6, which will be referred to as “fan” in the remainder of the description, is activated, the ambient air enters through the inlet 8 of the ventilation tube 20, and is heated inside the tube 20 by the heating means, then the hot air leaves the ventilation tube 20 through the outlet 9.

The heating means of each gun 2 may be of different types, and are for example a gas or gasoline combustion device supplied by a reservoir which stores the fuel in question. As an alternative and preferably, the heating means of the air gun 2 comprise an electrical resistor connected to a source of electrical energy, typically the electrical-energy distribution network. The fan 6 is likewise connected to the electrical-energy distribution network.

The heating resistor of each electric air gun 2 is supplied with a low voltage, for example a three-phase alternating voltage of around 400 volts, and is suitable for supplying a power of around 30 kilowatts and for reaching a temperature of around 1400 degrees Celsius, while the fan 6 is able to generate an air flow with a flow rate that can reach 2 kilograms per second. With these technical features, each air gun 2 is thus capable of generating a hot-air flow that potentially reaches a temperature of 900 degrees Celsius.

The heating resistor is made from a metal alloy configured to withstand temperatures above 1400 degrees Celsius. Such an alloy is for example of the iron-chromium-aluminum type, commonly known as “FeCrAl”.

Each air gun 2 comprises a control member controlling the off or on state of the electrical resistor, this member preferably being a solid-state relay which makes it possible to rapidly switch in around 100 milliseconds. In addition, in a particularly advantageous manner, this relay is configured to actuate when the AC supply voltage of the heating resistor is close to zero volts in the AC cycle. This avoids the generation of electrical harmonics around the fundamental frequency of the network.

According to the invention, the air guns 2 are distributed along at least one peripheral line 3a, 3b. In addition, each section of peripheral line 3a, 3b that groups together three adjacent air guns 2 is curved. In other words, each section of peripheral line that groups together three adjacent air guns 2 is not rectilinear. Two embodiments of the invention will now be described.

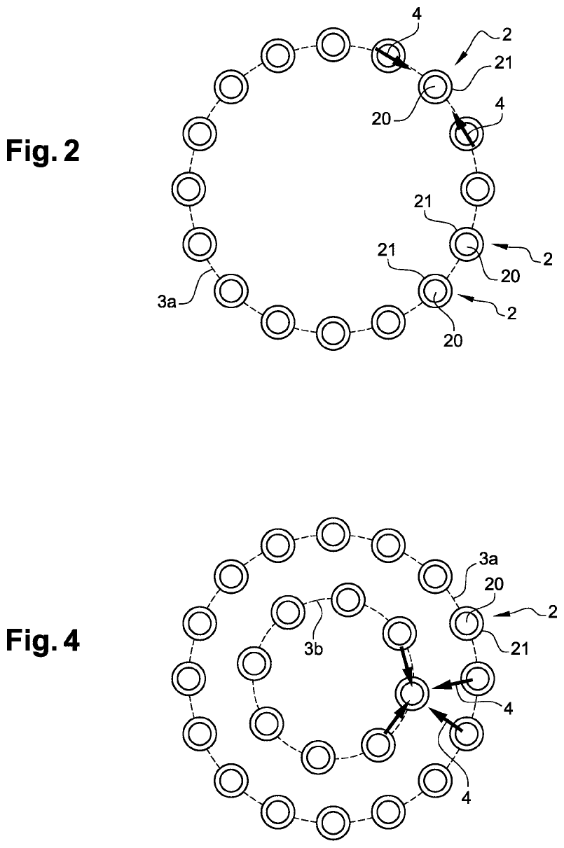

With reference to FIGS. 1 to 3, the air guns 2 are arranged in a single ring 3a. “Ring arrangement” is understood to mean any distribution of the air guns 2 along a periphery of defined shape. The shape of this periphery is advantageously circular, but other shapes are of course applicable without departing from the scope of the invention, in particular elliptical or polygonal shapes.

In this way, each air gun 2 of the assembly is subject to the thermal radiation 4 from only the two adjacent air guns 2. The thermal radiation 4 to which each air gun 2 of the assembly 1 is subject is therefore reduced in comparison with any other matrix arrangement of air guns in which some air guns are liable to be subject to the thermal radiation from eight adjacent guns.

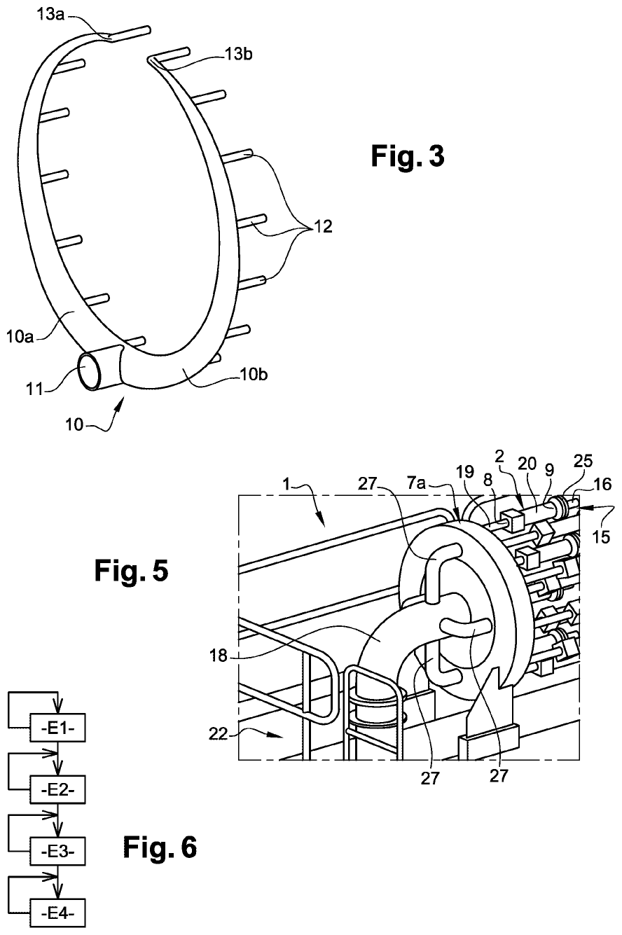

In order to fluidically connect the air guns 2 to the air supply means 7, and with reference to FIG. 3, these air supply means 7 comprise an air distribution member formed by an arched tube 10 with the same shape as that of the ring 3a on which the air guns 2 are distributed. Thus, if the ring 3a is circular, the arched tube 10 itself has a circular overall shape. In addition, the arched tube 10 faces the ring 3a forming the peripheral line on which the air guns 2 are distributed.

The arched tube 10 comprises an air inlet 11 connected to the main duct 18 by way of a secondary duct 26, and a plurality of air outlets 12 each connected to the inlet 8 of the ventilation tube 20 of the associated air gun 2. Each outlet 12 is formed by a rigid cylindrical conduit extending perpendicularly to the general plane of the arched tube 10, and the assembly of rigid outlet conduits 12 all have the same cross section.

The arched tube 10 does not form a complete circle but an open circle, the free ends 13a, 13b of which are hermetically sealed to prevent the air flow from escaping by any way other than through the rigid outlet conduits 12 provided for this purpose.

In order to ensure a constant speed of the air flow inside the arched tube 10, its cross section gradually decreases in the direction away from the air inlet 11. The gradual decrease in the cross section of the arched tube 10 is regulated such that the speed of the airflow at the outlet of the arched tube 10 is the same or approximately the same in all the rigid outlet conduits 12. Since these rigid outlet conduits 12 have identical cross sections, all the air guns 2 are supplied by air to be heated at the same flow rate. This ensures uniform operation of the heat generation assembly 1.

In addition, since the air inlet 11 is preferably disposed in a median plane of the arched tube 10, the two portions 10a, 10b of the arched tube 10 extending from said air inlet 11 are symmetrical with respect to said median plane.

With reference to FIG. 1, the rigid outlet conduits 12 are fluidically connected to the inlets 8 of the ventilation tubes 20 of the associated air guns 2 by flexible conduits 19. The suppleness of these flexible conduits 19 makes it possible to easily disconnect the air gun 2 from the corresponding rigid outlet conduit 12, and to easily install or remove one or more air guns 2 from the heat generation assembly 1. In addition, since the air flow entering the air guns 2 is at ambient temperature, it is not necessary to provide heat-resistant flexible conduits 19. Flexible conduits 19 made of soft plastics material are preferably used.

Still with reference to FIG. 1, the heat generation assembly 1 comprises a collector device 15 formed by a frustoconical air diffuser. This frustoconical diffuser 15 comprises a plurality of air inlets, each formed by a rigid duct 16 extending from the base 23 of the frustoconical diffuser 15, and an air outlet 17 connected to at least one heated-air outlet duct 24. Each air inlet 16 of the diffuser 15 is fluidically connected to the outlet 9 of the ventilation tube of the air gun 2 in question, by way of a flange-type fixing means 25 for facilitating the assembly or disassembly of the air guns 2.

In addition, the air inlets 16 of the diffuser 15 are distributed along a second peripheral line having the same shape as the ring 3a on which the air guns 2 are distributed. In other words, in this first embodiment, the two peripheral lines on which the air guns 2 and the air inlets 16 of the diffuser 15, respectively, are distributed are two coaxial rings with the same diameter.

With reference to FIGS. 4 and 5, and according to a second preferred embodiment of the invention, the air guns 2 are arranged in double rings 3a, 3b. Like the first embodiment, these rings 3a, 3b are advantageously circular, but other shapes are of course applicable without departing from the scope of the invention, in particular elliptical or polygonal shapes.

The air guns 2 are distributed along two concentric rings 3a, 3b with different diameters: an outer ring 3a and an inner ring 3b. In addition, as is shown in FIG. 5, the air guns 2 of the two rings 3a, 3b are disposed in a staggered manner, so as to increase the distance between the air guns 2 and therefore to limit the infrared radiation borne by each air gun 2.

In this way, each air gun 2 of the assembly is subject to the thermal radiation 4 from four adjacent air guns 2. The thermal radiation 4 to which each air gun 2 of the assembly 1 is subject is therefore reduced in comparison with any other matrix arrangement 1a of air guns.

In order to fluidically connect the air guns 2 to the air supply means 7a and with reference to FIG. 5, the latter comprise four air distribution members (not shown): two for the outer ring 3a and two for the inner ring 3b.

Each distribution member is formed by an arched tube intended for supplying air to a first half of the guns 2 of one and the same ring 3a, 3b. For each ring 3a, 3b, the heat generation assembly therefore comprises two semicircular arched tubes, the ends of which are hermetically sealed, each tube facing a section of that ring 3a, 3b on which the air guns 2 are distributed that is in question. In addition, the ends of an arched tube face the ends of another arched tube of one and the same ring 3a, 3b.

Like the arched tube 10 of the first embodiment of the invention, each arched tube in this second embodiment comprises an air inlet disposed in the median plane of said tube, this air inlet being connected to the main duct 18 by way of a secondary duct 27, and a plurality of air outlets each connected at the inlet 8 of the ventilation tube 20 of the associated air gun 2. Each outlet is formed by a rigid cylindrical conduit extending perpendicularly to the general plane of the arched tube, and the assembly of rigid outlet conduits of the arched tubes all have the same cross section.

In order to ensure a constant speed of the air flow inside the arched tubes, the cross section of each arched tube gradually decreases in the direction away from the air inlet in question. Thus, the speed of the air flow at the outlet of the arched tubes is the same in all the rigid outlet conduits of the four arched tubes. All the air guns 2 are therefore supplied by air to be heated at the same flow rate, ensuring uniform operation of the heat generation assembly.

With reference to FIG. 5, and like the first embodiment, the rigid outlet conduits of the arched tubes according to the second embodiment are fluidically connected to the inlets 8 of the ventilation tubes 20 of the associated air guns 2 by flexible conduits 19.

In this second embodiment, the arrangement of the air inlets 16 of the frustoconical diffuser 15 is adapted such that the air inlets 16 face the air guns 2 in question. Thus, the air inlets 16 of the frustoconical diffuser 15 are distributed along two concentric rings with the same diameters as the rings 3a, 3b on which the air guns 2 are distributed.

Irrespective of the embodiment of the invention, the air guns 2 of the heat generation assembly 1 according to the invention are better protected from thermal radiation 4. The service life of the guns 2 is therefore improved, and each gun 2 can operate at maximum performance without significantly increasing the risk of failure.

Advantageously, in order to further reduce and equalize the thermal radiation to which each gun 2 is subject, the air guns 2 are uniformly spaced apart at a distance of between 10 and 20 cm, and preferably of around 12 cm. It should be noted that a circular- or polygonal-ring arrangement of the air guns 2 still further homogenizes the thermal radiation to which each gun 2 is subject.

Lastly, an arrangement in a ring 3a or in double rings 3a, 3b affords the advantage of facilitating access to the air guns 2 by a user. Assembly or disassembly of each air gun 2 in the heat generation assembly 1 is therefore facilitated, and the maintenance operations are made simpler, shorter and cheaper.

Assembly in a double ring is even more advantageous for facilitating intervention operations, since it makes it possible to significantly reduce the size and bulk of the heat generation assembly 1.

Advantageously, in order to still further protect the air guns 2 from thermal radiation 4, said air guns may comprise thermal insulation means, for example a layer of thermally insulating material 21 surrounding the ventilation tube 20.

According to another advantage of the invention, inasmuch as the thermal radiation 4 to which the guns 2 is subject is reduced, the heat generation assembly 1 has a high power, greater than or equal to 600 kilowatts. The assembly 1 may therefore comprise between twenty and forty air guns 2, and preferably between thirty and thirty-five air guns 2.

Lastly, the air guns 2, and in particular the solid-state relays of the air guns 2, are all controlled by control means forming part of the heat generation assembly 1. These control means are preferably electronic and/or computer means, comprising in particular at least a processor and a memory space capable of storing instructions for a computer program able to be executed by the processor.

Advantageously, the solid-state relays can be controlled remotely and the control means are remote and configured to communicate with the solid-state relays via wireless communication means of the heat generation assembly 1. These wireless communication means may be of the Bluetooth or WiFi type, and are preferably telecommunications means using a known wireless telecommunications network, for example of the GSM type. In this way, the air guns 2 of the heat generation assembly 1 can be controlled at a large distance.

Advantageously, the control means are configured to control the air guns 2 independently of one another. The control means therefore make it possible to specifically select the air guns 2 that are to be activated.

In addition, the control means are configured to continuously, or at least periodically, collect information relating to the electricity distribution network, in particular the power delivered by the electrical-energy distribution network, at a given time.

Lastly, the control means are likewise configured to control the fan 6.

The invention likewise relates to a method for controlling the operational air guns 2 of a heat generation assembly 1, which method is implemented by the control means.

In a first step E1, the control means continuously monitor and determine the power delivered by the energy source to which the heat generation assembly 1 is connected, that is to say the power delivered by the electricity distribution network.

During a second step E2, the control means periodically determine the maximum number of air guns 2 that can be supplied in the optimum case as a function of the available power determined in the first step E1.

During the third step E3, the control means determine the number of operational air guns 2 in the heat generation assembly 1.

During the fourth and last step E4, the control means periodically determine the difference between the number of operational air guns 2 determined in the third step and the maximum number of air guns 2 that can be supplied in the optimum case. If the value of this difference is not zero, the control means regulate the number of operational guns 2 in the heat generation assembly 1 such that this number of guns 2 is at most equal to the maximum number of guns 2 that can operate in the optimum case.

Thus, the control means are configured to regulate in real time the number of operational air guns 2 in the heat generation assembly 1. In this way, the heat generation assembly 1 of the invention is perfectly suited to the power modulations delivered by the distribution network.

1. A heat generation assembly (1) comprising:
at least one air flow generation device,
air supply means fluidically connected to the air flow generation device,
at least three heating devices each comprising an air inlet connected to the air supply means, and
a heated-air outlet,
means for controlling the air flow generation device and the heating devices,
wherein the heating devices are distributed along at least one peripheral line, each section of peripheral line that groups together three adjacent heating devices being curved,
wherein the air supply means comprise at least one air distribution member formed by an arched tube in which are formed at least one air inlet connected at the outlet of the air flow generator and at least three air outlets, each of the air outlets being connected to the inlet of the associated heating device, and
wherein each arched tube portion that groups together three adjacent air outlets faces the section of peripheral line that groups together the three adjacent devices.

2. The assembly as claimed in claim 1, wherein the respective ends of the arched tube are hermetically sealed.

3. The assembly as claimed in claim 2, wherein the arched tube has a single air inlet, wherein the cross section of said arched tube gradually decreases in the direction away from the air inlet, and wherein the speed of the air flow is constant at all points of the arched tube.

4. The assembly as claimed in claim 3, wherein the air inlet is disposed in a median plane of the arched tube, and wherein two portions of the arched tube extending from the air inlet are symmetrical with respect to the median plane.

5. The assembly as claimed in claim 1, wherein the heating devices are evenly distributed along at least one circular ring.

6. The assembly as claimed in claim 5, wherein the heating devices are distributed along at least two concentric circular rings.

7. The assembly as claimed in claim 6, wherein the heating devices of two successive rings among the at least two concentric circular rings are disposed in a staggered manner.

8. The assembly as claimed in claim 4, wherein the assembly comprises at least one arched tube for each concentric ring of heating devices.

9. The assembly as claimed in claim 1, wherein the assembly comprises a frustoconical air diffuser having a plurality of air inlets, each of the air inlets being fluidly connected at the outlet of the associated heating device, and an outlet for air heated by the heating devices (2).

10. The assembly as claimed in claim 1, wherein the control means are configured to control the heating devices independently of one another.

11. The assembly as claimed in claim 10, wherein the control means are remote and configured to communicate with the heating devices via wireless communication means included in the assembly.

12. The assembly as claimed in claim 1, wherein the assembly comprises from twenty to forty heating devices.

13. The assembly as claimed in claim 1, wherein each heating device is spaced apart from an adjacent heating device by a distance of at least twelve centimeters.

14. A method for controlling a heat generation assembly as claimed in claim 1, comprising, implemented by the control means:
continuously monitoring power delivered by an energy source to which the assembly is connected;
periodically determining a maximum number of heating devices able to be supplied in an optimum case by the energy source as a function of available power;
periodically determining a number of operational heating devices in the assembly;
regulating in real time, as a function of the available power, a number of operational heating devices so that the number of operational heating devices is at most equal to the maximum number of heating devices calculated in the periodical determining of the maximum number of heating devices able to be supplied in the optimum case.

15. The assembly as claimed in claim 12, wherein the assembly comprises from thirty to thirty-five heating devices.

16. The assembly as claimed in claim 2, wherein the heating devices are evenly distributed along at least one circular ring.

17. The assembly as claimed in claim 16, wherein the heating devices are distributed along at least two concentric circular rings.

18. The assembly as claimed in claim 17, wherein the heating devices of two successive rings among the at least two concentric circular rings are disposed in a staggered manner.

19. The assembly as claimed in claim 3, wherein the heating devices are evenly distributed along at least one circular ring.

20. The assembly as claimed in claim 19, wherein the heating devices are distributed along at least two concentric circular rings.
